(19) United States
(12) Patent Application Publication
(10) Pub. No.: US 2017/0069245 A1
(43) Pub. Date: Mar. 9, 2017

(54) SOURCE-DRIVING CIRCUIT AND LIQUID CRYSTAL DISPLAY (LCD) PANEL THEREOF

(71) Applicants: SHENZHEN CHINA STAR OPTOELECTRONICS TECHNOLOGY CO., LTD., Shenzhen, Guangdong (CN); WUHAN CHINA STAR OPTOELECTRONICS TECHNOLOGY CO., LTD., Wuhan, Hubei (CN)

(72) Inventors: Zhenzhou XING, Shenzhen (CN); Tan Xoaping, Shenzhen (CN); Guo Xingling, Shenzhen (CN)

(21) Appl. No.: 14/893,936

(22) PCT Filed: Sep. 8, 2015
(86) PCT No.: PCT/CN2015/089137

§ 371 Date: Nov. 25, 2015

(51) Int. Cl. G09G 3/20; G02F 1/1362; G09G 3/36

(52) U.S. Cl. CPC G09G 3/2011; G09G 3/3696; G09G 3/3685; G09G 3/3674; G02F 1/136286; G09G 2310/027; G09G 2310/0224; G09G 2310/0251; G09G 2310/0289; G09G 2310/0291; G09G 2320/0276; G09G 2330/021

(57) ABSTRACT

The present invention provides a source-driving circuit and LCD panel thereof. In the source-driving circuit, the reference voltage signal outputted by the gamma voltage output module comprises a gamma reference voltage signal and a low voltage signal, wherein the voltage value of the low voltage signal is less than that of the gamma reference voltage signal, and the duration interval of the reference voltage signal is equal to that of the current gamma reference voltage signal. In comparison to the conventional technique, the power consumption of the source-driving circuit is reduced and the power consumption of the high resolution display panel is further decreased.

### BACKGROUND OF THE INVENTION

Field of Invention

The present invention relates to a technical field of a liquid crystal display (LCD), and more particularly to a source-driving circuit and LCD panel thereof.

Description of Prior Art

Conventionally, with the increased resolution of the small to medium panel sizes in the mobile phones, an inadequate power-charging phenomenon of the pixel unit on the display panel occurs if the original charging technology is used to charge the high resolution panel.

In the light of inadequate power-charging phenomenon of the pixel unit on the display panel, many conventional techniques provide some mature solutions. However, a common issue existing in these solutions is that the power consumption of the high resolution panel is severely increased. For the electronic apparatuses such as mobile phones, the standby time of the battery has been widely criticized. The wattage consumption rises and thus, the standby time of the electronic apparatuses is reduced.

For example, a solution for an inadequate power-charging phenomenon of the pixel unit with increasingly panel resolution is that a gate signal in the high resolution panel is simultaneously used to control the on/off statuses of the two gate lines and the gray level voltage signals transmitted by two source lines charge the pixel units on the gate line, respectively wherein the gray level voltage signals are gamma reference voltage, e.g. Vr1 to Vr5 and Vr6 to Vr15 when the source-driving circuit processes the equal duration outputted from the gamma generation unit.

Based on the aforementioned solutions, the power consumption of the source-driving circuit is increased although the inadequate power-charging phenomenon is solved, resulting in increment of the power consumption of the high resolution panel.

Consequently, there is a need to develop a source-driving circuit and LCD panel thereof to solve the problems of the conventional technique.

### SUMMARY OF THE INVENTION

One objective of the present invention is to provide a source-driving circuit to solve the problem of the higher power consumption of the high resolution display panel.

To solve the above-mentioned problems, the present invention sets forth the following technical scheme.

One embodiment of the present invention provides a source-driving circuit, comprising:

a column buffer, a level shifter, a digital-to-analog converter, an output buffer and a gamma voltage output module;

wherein the column buffer is used to store an inputted video signal and outputs the stored video signal to the level shifter;

wherein the level shifter is used to amplify a voltage of the video signal for activating the digital-to-analog converter;

wherein the gamma voltage output module is used to output a plurality of reference voltage signals having an equal duration interval to the digital-to-analog converter; each reference voltage signal comprises a gamma reference voltage signal; at least one reference voltage signal further comprises a low voltage signal wherein a voltage value of the low voltage signal is less than that of the gamma reference voltage signal; a duration interval of the reference voltage signal is equal to that of a current gamma reference voltage signal; the duration interval of each low voltage signal is equal each other; and the voltage value of the low voltage signal is zero;

wherein the digital-to-analog converter is used to perform a digital-to-analog transformation to convert the reference voltage signal into an analog voltage signal and the digital-to-analog converter outputs the analog voltage signal to the output buffer; and

wherein the output buffer is used to amplify the analog voltage signal to generate a gray level voltage signal and the output buffer outputs the gray level voltage signal to a display panel for driving a corresponding pixel unit.

In the source-driving circuit, the duration interval of the low voltage signal is determined according to the duration interval of a screen display of the corresponding pixel unit.

In the source-driving circuit, if the reference voltage signal comprising the gamma reference voltage signal and the low voltage signal, an outputting time of the gamma reference voltage signal is earlier than that of the low voltage signal.

In the source-driving circuit, the duration interval of the low voltage signal is determined according to the duration interval of a screen display of the corresponding pixel unit; and if the reference voltage signal comprising the gamma reference voltage signal and the low voltage signal, an outputting time of the gamma reference voltage signal is earlier than that of the low voltage signal.

In the source-driving circuit, the reference voltage signals further comprise the low voltage signal.

In the source-driving circuit, the gamma voltage output module comprises a gamma voltage generation module and a control output module; wherein the gamma voltage generation module is used to generate a reference voltage signal which comprises the gamma reference voltage signal and the low voltage signal; and the voltage value of the low voltage signal is zero; and wherein the control output module is used to control the gamma voltage generation module for outputting the reference voltage signal to the digital-to-analog converter; and the reference voltage signal comprises a plurality of equal duration intervals.

Another embodiment of the present invention provides a source-driving circuit, comprising:

a column buffer, a level shifter, a digital-to-analog converter, an output buffer and a gamma voltage output module;

wherein the column buffer is used to store an inputted video signal and outputs the stored video signal to the level shifter;

wherein the level shifter is used to amplify a voltage of the video signal for activating the digital-to-analog converter;

wherein the gamma voltage output module is used to output a plurality of reference voltage signals having an equal duration interval to the digital-to-analog converter; each reference voltage signal comprises a gamma reference voltage signal; at least one reference voltage signal further comprises a low voltage signal wherein a voltage value of the low voltage signal is less than that of the gamma reference voltage signal; a duration interval of the reference voltage signal is equal to that of a current gamma reference voltage signal;

wherein the digital-to-analog converter is used to perform a digital-to-analog transformation to convert the reference voltage signal into an analog voltage signal and the digital-to-analog converter outputs the analog voltage signal to the output buffer; and

wherein the output buffer is used to amplify the analog voltage signal to generate a gray level voltage signal and the output buffer outputs the gray level voltage signal to a display panel for driving a corresponding pixel unit.

In the source-driving circuit, the voltage value of the low voltage signal is zero.

In the source-driving circuit, the duration interval of each low voltage signal is equal each other.

In the source-driving circuit, the duration interval of the low voltage signal is determined according to the duration interval of a screen display of the corresponding pixel unit.

In the source-driving circuit, if the reference voltage signal comprising the gamma reference voltage signal and the low voltage signal, an outputting time of the gamma reference voltage signal is earlier than that of the low voltage signal. The reference voltage signals further comprise the low voltage signal.

In the source-driving circuit, the gamma voltage output module comprises a gamma voltage generation module and a control output module; wherein the gamma voltage generation module is used to generate a reference voltage signal which comprises the gamma reference voltage signal and the low voltage signal; and the voltage value of the low voltage signal is zero; and wherein the control output module is used to control the gamma voltage generation module for outputting the reference voltage signal to the digital-to-analog converter; and the reference voltage signal comprises a plurality of equal duration intervals.

Still another embodiment of the present invention provides a liquid crystal display (LCD) panel, comprising:

an array substrate comprising a plurality of scanning lines, a plurality of data lines and plurality of pixel units;

wherein the scanning lines are used to transmit scanning signals;

wherein the data lines are used to transmit gray level voltage signals;

wherein the pixel units are defined by interlacing the scanning lines and the data lines for displaying the screen based on the scanning signals and the gray level voltage signals;

a source-driving circuit comprising a column buffer, a level shifter, a digital-to-analog converter, an output buffer and a gamma voltage output module;

wherein the column buffer is used to store an inputted video signal and outputs the stored video signal to the level shifter;

wherein the level shifter is used to amplify a voltage of the video signal for activating the digital-to-analog converter;

wherein the gamma voltage output module is used to output a plurality of reference voltage signals having an equal duration interval to the digital-to-analog converter; each reference voltage signal comprises a gamma reference voltage signal; at least one reference voltage signal further comprises a low voltage signal wherein a voltage value of the low voltage signal is less than that of the gamma reference voltage signal; a duration interval of the reference voltage signal is equal to that of a current gamma reference voltage signal;

wherein the digital-to-analog converter is used to perform a digital-to-analog transformation to convert the reference voltage signal into an analog voltage signal and the digital-to-analog converter outputs the analog voltage signal to the output buffer; and

wherein the output buffer is used to amplify the analog voltage signal to generate a gray level voltage signal and the output buffer outputs the gray level voltage signal to a display panel for driving a corresponding pixel unit.

In the LCD panel, the reference voltage signals further comprise the low voltage signal.

In the LCD panel, the voltage value of the low voltage signal is zero.

In the LCD panel, the duration interval of each low voltage signal is equal each other.

In the LCD panel, if the reference voltage signal comprising the gamma reference voltage signal and the low voltage signal, an outputting time of the gamma reference voltage signal is earlier than that of the low voltage signal.

In the LCD panel, the duration interval of the low voltage signal is determined according to the duration interval of a screen display of the corresponding pixel unit.

In the LCD panel, the gamma voltage output module comprises a gamma voltage generation module and a control output module;

wherein the gamma voltage generation module is used to generate a reference voltage signal which comprises the gamma reference voltage signal and the low voltage signal; and the voltage value of the low voltage signal is zero; and

wherein the control output module is used to control the gamma voltage generation module for outputting the reference voltage signal to the digital-to-analog converter; and the reference voltage signal comprises a plurality of equal duration intervals.

The present invention provides a source-driving circuit and LCD panel thereof. The gamma voltage output module of the source-driving circuit in the present invention is used to output a plurality of reference voltage signals having an equal duration interval to the digital-to-analog converter; each reference voltage signal comprises a gamma reference voltage signal; at least one reference voltage signal further comprises a low voltage signal wherein a voltage value of the low voltage signal is less than that of the gamma reference voltage signal; a duration interval of the reference voltage signal is equal to that of a current gamma reference voltage signal; and the duration interval of each low voltage signal is equal each other. In comparison to the conventional technique, in addition to outputting a gamma reference voltage signal during the duration interval of the current gamma reference voltage signal by the digital-to-analog converter of the present invention, the digital-to-analog converter further outputs a low voltage signal, which means that a portion of gamma reference voltage signal is pulled down within the duration interval of the current gamma reference voltage signal. Since the power consumption of the source-driving circuit is reduced, the power consumption of the high resolution panel is decreased.

### BRIEF DESCRIPTION OF THE DRAWINGS

FIG. 1 is a schematic structural view of a source-driving circuit according to one embodiment of the present invention;

FIG. 2 is a schematic timing diagram of a gamma reference voltage according to one embodiment of the present invention; and

FIG. 3 is a schematic structural view of a source-driving circuit according to another embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto. In the drawings, the same reference symbol represents the same or a similar component.

### Embodiment 1

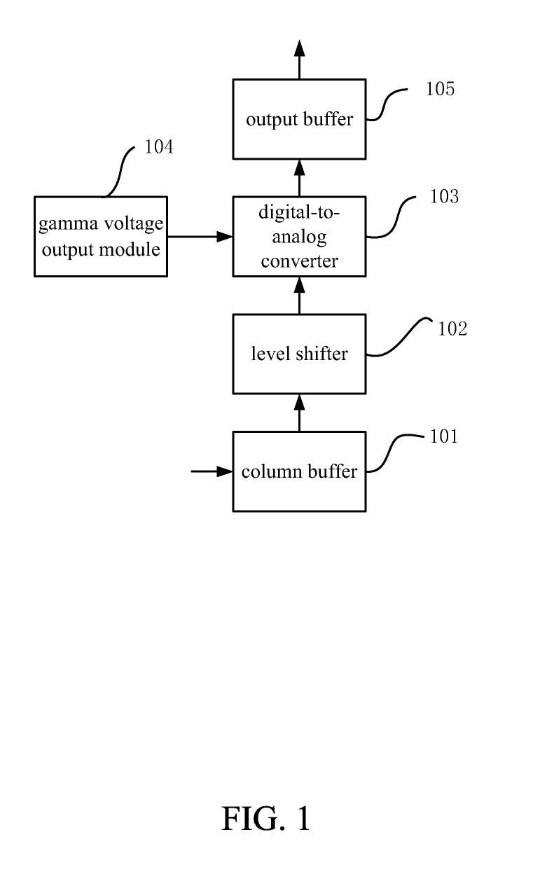

In order to reduce the power consumption of the high resolution panel, the present invention provides a source-driving circuit, as shown in FIG. 1. The source-driving circuit comprises a column buffer 101, a level shifter 102, a digital-to-analog converter 103, a gamma voltage output module 104 and an output buffer 105.

The column buffer 101 is used to store the inputted video signal and outputs the stored video signal to the level shifter.

The level shifter 102 is used to amplify the voltage of the video signal for activating the digital-to-analog converter 103.

The gamma voltage output module 104 is used to output the reference voltage signals having the equal duration intervals to the digital-to-analog converter 103 wherein each reference voltage signal comprises a gamma reference voltage signal. At least one reference voltage signal further comprises a low voltage signal wherein the voltage value of the low voltage signal is less than that of the gamma reference voltage signal. The duration interval of the reference voltage signal is equal to that of the current gamma reference voltage signal.

The digital-to-analog converter 103 is used to perform the digital-to-analog transformation to convert the reference voltage signal into an analog voltage signal and outputs the analog voltage signal to the output buffer 105.

The output buffer 105 is used to amplify the analog voltage signal to generate a gray level voltage signal and the output buffer 105 outputs the gray level voltage signal to display panel for driving the corresponding pixel unit.

In the source-driving circuit of the present invention, in addition to outputting a gamma reference voltage signal during the duration interval of the current gamma reference voltage signal by the digital-to-analog converter 103, the digital-to-analog converter 103 further outputs a low voltage signal, which means that a portion of gamma reference voltage signal is pulled down within the duration interval of the current gamma reference voltage signal. Since the power consumption of the source-driving circuit is reduced, the power consumption of the high resolution panel is decreased to improve the user's experience.

In order to further reduce the power consumption of the source-driving circuit, the reference voltage signal further comprises a low voltage signal. In other words, one potion of each current gamma reference voltage signals is pulled down.

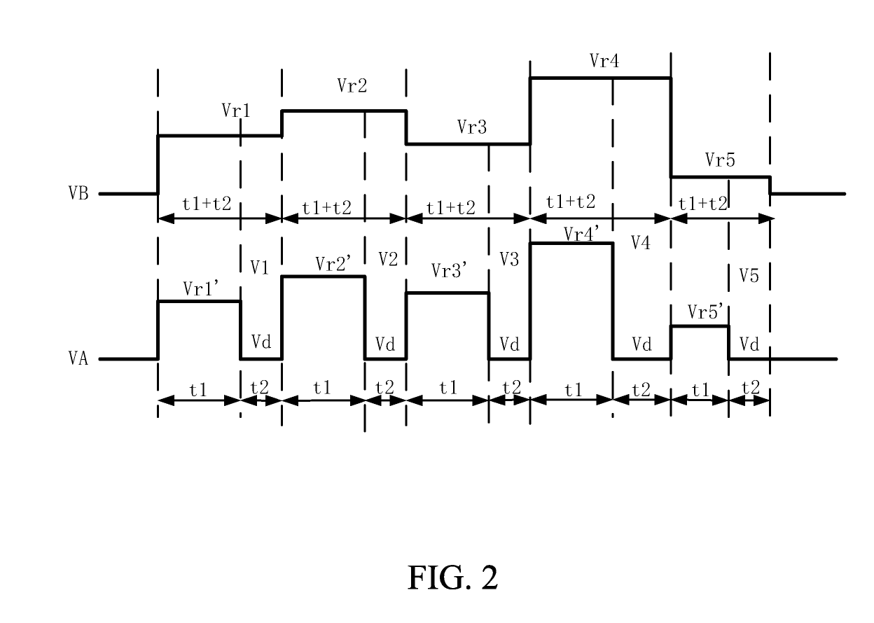

As shown in FIG. 2, the gamma voltage output module 104 of the present invention outputs a voltage signal “VA” which is composed of five reference voltages V1 to V5 for example. The duration interval of the current gamma reference voltage signal is “t1+t2” and the gamma generation unit outputs voltage signal “VB” comprises five the current gamma reference voltage signals Vr1 to Vr5.

In the present invention, the low voltage signal is defined as “Vd” and the gamma reference voltage signals are defined as Vr1′ to Vr5′. In FIG. 2, each reference voltage signals comprises the gamma reference voltage signal and the low voltage signal Vd. Specifically, V1 is composed of Vr1′ and Vd wherein Vd is less than Vr1′; V2 is composed of Vr2′ and Vd wherein Vd is less than Vr2′; . . . ; and V5 is composed of Vr5′ and Vd wherein Vd is less than Vr5′. In FIG. 2, the duration interval of the gamma reference voltage signal in the reference voltage signal is “t1” and the duration interval of the low voltage signal is “t2”. Particularly, the duration intervals of “Vr1′” to “Vr5′” are “t1”.

As shown in FIG. 2, in comparison with the voltage signal VB outputted by the current gamma generation unit and the voltage signal VA outputted by the gamma voltage output module 104 of the present invention, the gamma reference voltage signal, e.g. Vr1′ or Vr5′, and low voltage signal Vd are outputted during the duration interval “t1+t2”. Specifically, the gamma reference voltage signals are outputted during the duration interval “t1” and low voltage signals are outputted during the duration interval “t2”.

However, the current gamma reference voltage signal, e.g. Vr1, Vr2 or Vr5, is outputted during the duration interval “t1+t2”. Therefore, the voltage signal outputted during the duration interval “t2” is advantageously reduced to decrease the power consumption of the source-driving circuit.

Preferably, in order to further reduce the power consumption of the source-driving circuit, the voltage value of the low voltage signal is zero; meanwhile, the gamma voltage output module 104 outputs the voltage signal during the duration interval “t2” for saving the power consumption of the outputted voltage signal during the duration interval “t2”.

Preferably, in order to conveniently output the voltage signal, the duration interval of each low voltage signal is equal each other and the duration interval of the gamma reference voltage signal in the reference voltage signal is also equal. This enables the gamma voltage output module 104 outputs the low voltage signal with uniform duration interval.

The present invention takes different charging duration interval, i.e. different duration interval of the screen display, of each column pixel unit into account. If the gamma reference voltage signal with the same duration interval is employed to charge each column pixel unit, a portion of the gamma reference voltage signal is redundant due to the same duration interval which increases the power consumption. In one case, it is theoretically required to charge one column pixel unit by using two seconds of the duration interval but in fact, the gamma reference voltage signal with the three seconds of the duration interval are applied to the are used to the one column pixel unit. Alternatively, if the charging time of some pixel units is inadequate, the screen display quality is downgraded. For example, it is theoretically required to charge one column pixel unit by using three seconds of the duration interval but in fact, the gamma reference voltage signal with the two seconds of the duration interval are applied to the are used to the one column pixel unit.

Based on the above problems, the gamma voltage output module 104 of the source-driving circuit in the present invention is capable of determining the duration interval of the low voltage signal according to the duration interval of the screen display of the corresponding pixel unit and outputting the gamma reference voltage signal with corresponding duration interval for satisfying the requirement of the charging time for the pixel unit. Therefore, at least two duration intervals of the low voltage signals may be different.

Preferably, in order to speed up the screen display velocity of the display panel during the initial driving stage, the screen extending display during the initial driving stage is reduced. If the reference voltage signal comprising the gamma reference voltage signal and the low voltage signal of the embodiment of the present invention, the outputting time of the gamma reference voltage signal is earlier than that of the low voltage signal. As shown in FIG. 2, the outputting time of the gamma reference voltage signal Vr1′ is earlier than that of the low voltage signal Vd, and the outputting time of the gamma reference voltage signal Vr2′ is earlier than that of the low voltage signal Vd.

Since the outputting time of the gamma reference voltage signal is earlier than that of the low voltage signal, the pixel unit receives the corresponding gray level voltage signal in advance and the pixel unit is driven to display the screen.

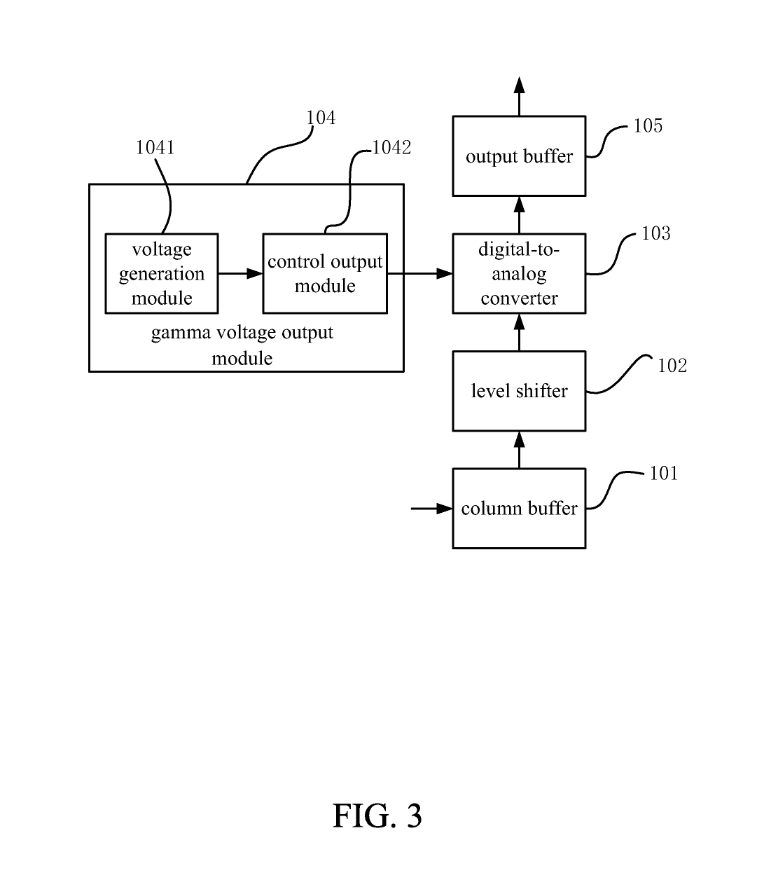

If the outputting time of the low voltage signal is earlier than that of the gamma reference voltage signal, the pixel unit receives the low voltage signal in advance but the low voltage signal cannot drive the pixel unit not to display the screen. Only after waiting for a period, the pixel unit receives the gray level voltage signal and the pixel unit is driven to display the screen. The structure of the gamma voltage output module 104 is described below. As shown in FIG. 3, the gamma voltage output module 104 comprises a gamma voltage generation module 1041 and a control output module 1042.

The gamma voltage generation module 1041 is used to generate a reference voltage signal which comprises a gamma reference voltage signal and a low voltage signal wherein the voltage value of the low voltage signal is zero.

The control output module 1042 is used to control the gamma voltage generation module 1041 for outputting the reference voltage signal to the digital-to-analog converter 103 wherein the reference voltage signal comprises a plurality of equal duration intervals.

In the embodiment of the present invention, the gamma voltage generation module 1041 generates two voltage signals comprising a gamma reference voltage signal and a low voltage signal. The control output module 1042 controls the gamma voltage output module 104 to output the gamma reference voltage signal for charging the pixel unit during the first predetermined intervals and to output the low voltage signal for forming the voltage signal similar to the signal in the FIG. 2.

In comparison to the conventional technique, the source-driving circuit of the present invention is capable of reducing the power consumption of the display panel to decrease the power consumption of the electronic apparatuses having the display panel and to increase the standby time the electronic apparatuses in order to improve the user's experience. Furthermore, the source-driving circuit of the present invention has many advantages including easy implement, wide application and lower manufacturing cost.

### Embodiment 2

The present invention provides a LCD panel comprising: an array substrate including a plurality of scanning lines, a plurality of data lines and plurality of pixel units; the scanning lines used to transmit scanning signals; the data lines used to transmit gray level voltage signals; the pixel units defined by interlacing the scanning lines and the data lines for displaying the screen based on the scanning signals and the gray level voltage signals; and a source-driving circuit comprising a column buffer, a level shifter, a digital-to-analog converter, an output buffer and a gamma voltage output module.

The column buffer is used to store the inputted video signal and outputs the stored video signal to level shifter.

The level shifter is used to amplify the voltage of the video signal for activating the digital-to-analog converter.

The gamma voltage output module 104 is used to output the reference voltage signals having the equal duration intervals to the digital-to-analog converter wherein the reference voltage signals comprises gamma reference voltage signals. At least one reference voltage signal further comprises a low voltage signal wherein the voltage value of the low voltage signal is less than that of the gamma reference voltage signal. The duration of the reference voltage signals are equal to these of the gamma reference voltage signals.

The digital-to-analog converter is used to perform the digital-to-analog transformation to convert the reference voltage signal into an analog voltage signal and outputs the analog voltage signal to the output buffer.

The output buffer is used to amplify the analog voltage signal to generate a gray level voltage signal and the output buffer outputs the gray level voltage signal to display panel for driving the corresponding pixel unit.

The source-driving circuit of the present invention is depicted in FIG. 1.

In the source-driving circuit of the LCD panel in the present invention, in addition to outputting a gamma reference voltage signal during the duration interval of the current gamma reference voltage signal, the source-driving circuit further outputs a low voltage signal, which means that a portion of gamma reference voltage signal is pulled down within the duration interval of the current gamma reference voltage signal. Since the power consumption of the source-driving circuit is reduced, the power consumption of the display panel is decreased. Preferably, in order to further reduce the power consumption, the reference voltage signals further comprises the low voltage signal.

Preferably, in order to further reduce the power consumption, the voltage value of the voltage signal is zero.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A source-driving circuit, comprising:
a column buffer, a level shifter, a digital-to-analog converter, an output buffer and a gamma voltage output module;
wherein the column buffer is used to store an inputted video signal and outputs the stored video signal to the level shifter;
wherein the level shifter is used to amplify a voltage of the video signal for activating the digital-to-analog converter;
wherein the gamma voltage output module is used to output a plurality of reference voltage signals having an equal duration interval to the digital-to-analog converter; each reference voltage signal comprises a gamma reference voltage signal;
at least one reference voltage signal further comprises a low voltage signal wherein a voltage value of the low voltage signal is less than that of the gamma reference voltage signal; a duration interval of the reference voltage signal is equal to that of a current gamma reference voltage signal; the duration interval of each low voltage signal is equal each other; and the voltage value of the low voltage signal is zero;
wherein the digital-to-analog converter is used to perform a digital-to-analog transformation to convert the reference voltage signal into an analog voltage signal and the digital-to-analog converter outputs the analog voltage signal to the output buffer; and
wherein the output buffer is used to amplify the analog voltage signal to generate a gray level voltage signal and the output buffer outputs the gray level voltage signal to a display panel for driving a corresponding pixel unit.

2. The source-driving circuit of claim 1, wherein the duration interval of the low voltage signal is determined according to the duration interval of a screen display of the corresponding pixel unit.

3. The source-driving circuit of claim 1, wherein if the reference voltage signal comprising the gamma reference voltage signal and the low voltage signal, an outputting time of the gamma reference voltage signal is earlier than that of the low voltage signal.

4. The source-driving circuit of claim 2, wherein if the reference voltage signal comprising the gamma reference voltage signal and the low voltage signal, an outputting time of the gamma reference voltage signal is earlier than that of the low voltage signal.

5. The source-driving circuit of claim 1, wherein the reference voltage signals further comprise the low voltage signal.

6. The source-driving circuit of claim 1, wherein the gamma voltage output module comprises a gamma voltage generation module and a control output module;
wherein the gamma voltage generation module is used to generate a reference voltage signal which comprises the gamma reference voltage signal and the low voltage signal; and the voltage value of the low voltage signal is zero; and
wherein the control output module is used to control the gamma voltage generation module for outputting the reference voltage signal to the digital-to-analog converter; and the reference voltage signal comprises a plurality of equal duration intervals.

7. A source-driving circuit, comprising:
a column buffer, a level shifter, a digital-to-analog converter, an output buffer and a gamma voltage output module;
wherein the column buffer is used to store an inputted video signal and outputs the stored video signal to the level shifter;
wherein the level shifter is used to amplify a voltage of the video signal for activating the digital-to-analog converter;
wherein the gamma voltage output module is used to output a plurality of reference voltage signals having an equal duration interval to the digital-to-analog converter; each reference voltage signal comprises a gamma reference voltage signal;
at least one reference voltage signal further comprises a low voltage signal wherein a voltage value of the low voltage signal is less than that of the gamma reference voltage signal; a duration interval of the reference voltage signal is equal to that of a current gamma reference voltage signal;
wherein the digital-to-analog converter is used to perform a digital-to-analog transformation to convert the reference voltage signal into an analog voltage signal and the digital-to-analog converter outputs the analog voltage signal to the output buffer; and
wherein the output buffer is used to amplify the analog voltage signal to generate a gray level voltage signal and the output buffer outputs the gray level voltage signal to a display panel for driving a corresponding pixel unit.

8. The source-driving circuit of claim 7, wherein the voltage value of the low voltage signal is zero.

9. The source-driving circuit of claim 7, wherein the duration interval of each low voltage signal is equal each other.

10. The source-driving circuit of claim 7, wherein the duration interval of the low voltage signal is determined according to the duration interval of a screen display of the corresponding pixel unit.

11. The source-driving circuit of claim 7, wherein if the reference voltage signal comprising the gamma reference voltage signal and the low voltage signal, an outputting time of the gamma reference voltage signal is earlier than that of the low voltage signal.

12. The source-driving circuit of claim 7, wherein the reference voltage signals further comprise the low voltage signal.

13. The source-driving circuit of claim 7, wherein the gamma voltage output module comprises a gamma voltage generation module and a control output module;
wherein the gamma voltage generation module is used to generate a reference voltage signal which comprises the gamma reference voltage signal and the low voltage signal; and the voltage value of the low voltage signal is zero; and
wherein the control output module is used to control the gamma voltage generation module for outputting the reference voltage signal to the digital-to-analog converter; and the reference voltage signal comprises a plurality of equal duration intervals.

14. A liquid crystal display (LCD) panel, comprising:
an array substrate comprising a plurality of scanning lines, a plurality of data lines and plurality of pixel units;
wherein the scanning lines are used to transmit scanning signals;
wherein the data lines are used to transmit gray level voltage signals;
wherein the pixel units are defined by interlacing the scanning lines and the data lines for displaying the screen based on the scanning signals and the gray level voltage signals;
a source-driving circuit comprising a column buffer, a level shifter, a digital-to-analog converter, an output buffer and a gamma voltage output module;
wherein the column buffer is used to store an inputted video signal and outputs the stored video signal to the level shifter;
wherein the level shifter is used to amplify a voltage of the video signal for activating the digital-to-analog converter;
wherein the gamma voltage output module is used to output a plurality of reference voltage signals having an equal duration interval to the digital-to-analog converter; each reference voltage signal comprises a gamma reference voltage signal;
at least one reference voltage signal further comprises a low voltage signal wherein a voltage value of the low voltage signal is less than that of the gamma reference voltage signal; a duration interval of the reference voltage signal is equal to that of a current gamma reference voltage signal;
wherein the digital-to-analog converter is used to perform a digital-to-analog transformation to convert the reference voltage signal into an analog voltage signal and the digital-to-analog converter outputs the analog voltage signal to the output buffer; and
wherein the output buffer is used to amplify the analog voltage signal to generate a gray level voltage signal and the output buffer outputs the gray level voltage signal to a display panel for driving a corresponding pixel unit.

15. The LCD panel of claim 14, wherein the reference voltage signals further comprise the low voltage signal.

16. The LCD panel of claim 14, wherein the voltage value of the low voltage signal is zero.

17. The LCD panel of claim 14, wherein the duration interval of each low voltage signal is equal each other.

18. The LCD panel of claim 14, wherein if the reference voltage signal comprising the gamma reference voltage signal and the low voltage signal, an outputting time of the gamma reference voltage signal is earlier than that of the low voltage signal.

19. The LCD panel of claim 14, wherein the duration interval of the low voltage signal is determined according to the duration interval of a screen display of the corresponding pixel unit.

20. The LCD panel of claim 14, wherein the gamma voltage output module comprises a gamma voltage generation module and a control output module;
wherein the gamma voltage generation module is used to generate a reference voltage signal which comprises the gamma reference voltage signal and the low voltage signal; and the voltage value of the low voltage signal is zero; and
wherein the control output module is used to control the gamma voltage generation module for outputting the reference voltage signal to the digital-to-analog converter; and the reference voltage signal comprises a plurality of equal duration intervals.
